(19) United States
(12) Patent Application Publication
(10) Pub. No.: US 2023/0129502 A1
(43) Pub. Date: Apr. 27, 2023

(54) VEHICLE COVER AND SECUREMENT SYSTEM

(71) Applicant: Charles McKee, Del Mar, CA (US)

(72) Inventor: Charles McKee, Del Mar, CA (US)

(21) Appl. No.: 17/510,165

(22) Filed: Oct. 25, 2021

(51) Int. Cl. B60J 11/04; F16G 11/04

(52) U.S. Cl. CPC B60J 11/04; F16G 11/04

(57) ABSTRACT

A vehicle cover is provided, having a flexible fabric body defining an interior cavity which is positionable over an vehicle. Elastic members positioned in passages at the front and rear of the cover are stretchable to mounts on the sides of the cover, to stretch and impart a bias to the elastic member to form a biased contact of the cover with the vehicle.

### BACKGROUND OF THE INVENTION

### 1. Field of the Invention

The present invention relates generally to protective vehicle covers such as those employed on passenger vehicles and boats and the like. More particularly, the invention relates to a vehicle cover having a securement configuration which is adapted to biasly engage both ends and a central section of the cover at a single engagement position in a middle area of the vehicle being covered.

### 2. Prior Art

Vehicle covers are widely employed as a means to protect vehicles from the ravages of sun and the elements. Weather such as heavy rain, hail, snow, and sand storms and the like, can all damage the exterior of vehicles such as cars, trucks, RVs and boats. Such vehicle covers also are employed to protect vehicles from significant damage which can result from long term exposure to sunlight. The ultraviolet spectrum of sunlight is well known to cause serious damage to paint and to polymeric coatings and resins used to both form and to form coverings over land vehicles and also boats.

Where a car or boat or recreational vehicle is used only for recreational purposes, they tend to be stored for long periods. Such storage outdoors can cause significant exposure to weather and sunlight for long periods of time and significant damage to the exterior surfaces of such stored vehicles.

To that end, many owners of vehicles, whether stored outdoors for short periods of time or long durations, have chosen to purchase and employ vehicle covers to protect their investment from such weather related damage. Such vehicle covers are conventionally formed of a flexible fabric which is woven or knitted or otherwise formed to a planar flexible material.

Particularly preferred are woven or knitted products which allow some air passage through the material to lower the potential for water vapor formation on the covered vehicle. Such material generally will be woven with gaps between fibers that allow for venting of any build up of water vapor, while still providing protection from weather and sun.

Conventionally, vehicle owners can purchase a vehicle cover which is either configured to engage over a wide variety of vehicles. Alternatively, vehicle owners can also purchase vehicle covers which are specifically configured to form fit over their specific car, truck, boat, or recreational vehicle.

Many such generalized and customized vehicle covers are prone to disengagement from the covered vehicle from the force of wind. As such, both custom and generalized covers frequently provide connectors such as grommets or the like, so as to allow users to engage a restraint to hold the vehicle cover to the covered vehicle. This prevents the disengagement of the cover during windstorms or during towing and vehicle transport.

The forgoing examples of related art for vehicle covers and limitations related therewith are intended to be illustrative and not exclusive, and they do not imply any limitations on the invention described and claimed herein. Various limitations of the related vehicle cover art will become apparent to those skilled in the art upon a reading and understanding of the specification below and the accompanying drawings.

With respect to the above, before explaining at least one preferred embodiment of the vehicle cover and securement system therefor herein, it is to be understood that the disclosed device and system are not limited in application to the details of employment and to the arrangement of the components or the steps set forth in the following description or illustrated in the drawings. The various apparatus and operations of the herein disclosed biasly secured vehicle covers are capable of other embodiments, and of being practiced and carried out in various ways, all of which will be obvious to those skilled in the art once the information herein is reviewed.

Also, it is to be understood that the phraseology and terminology employed herein are for the purpose of description, and should not be regarded as limiting. As such, those skilled in the art will appreciate that the conception upon which this disclosure is based, may readily be utilized as a basis for the manufacture and provision of other vehicle covers and securement systems therefor. It is important, therefore, that the embodiments, objects and claims herein, be regarded as including such equivalent construction and methodology insofar as they do not depart from the spirit and scope of the present invention.

### SUMMARY OF THE INVENTION

The device herein disclosed and described provides a solution to the shortcomings in prior art of vehicle covers and securement employed therewith. The vehicle cover device herein, is configured with a body formed from a flexible material which may have a generalized shape and configuration to fit many types of vehicles. More preferably, the body of the vehicle cover herein is configured in a more custom fashion such that it conforms to form a covering to the shape of a specific land or marine vehicle or group thereof having substantially the same shape and contours.

Preferably, the flexible fabric forming the body of the vehicle cover is formed of fabric which is formed of yarn or threads or other material which is resistant to degradation over time from ultraviolet light which will contact it from sunlight. Such material, for example, is manufactured by SUNBRELLA in woven and knitted configurations. Additionally preferred is that the material forming the body of the vehicle cover substantially resists passage of water therethrough, to thereby protect the covered vehicle form rain, snow, and other weather.

In all modes of the vehicle cover device herein, a first or frontal passage has a first elastic member communicating through the first passage formed at or adjacent a lower edge of the cover at the front end of the body of the vehicle cover. First extensions of this first elastic member are included which communicate to respective distal ends extending from both sides of the first passage which can be secured to a mount in an engagement to a central area of the body of the vehicle cover.

Additionally included, in the vehicle cover device herein, is a second or rear passage positioned on or adjacent a lower edge of the body of the vehicle cover which has a second elastic member communicating through the second passage formed at the rear end of the body of the vehicle cover. Secondary extensions of this second elastic member are included which communicate to respective distal ends thereof on both sides of the body of the cover. These secondary extensions can be secured directly to or indirectly with the same mount which is in the engagement with the central area of the body of the vehicle cover.

Such elastic members, employed for the first and second elastic members, are available in the form of conventional rubber rope, or for example, elastic cord composed of one or more elastic strands which form a core, which is conventionally surrounded by a woven or knitted fabric sheath. Consequently, by elastic member or members as used herein, is meant any stretchable member formed of a polymeric or rubber like material or cord or the like, which will elongate when stretched, and which thereafter, will biasly retract toward the original length of the flexible member.

The vehicle cover device as shown herein, in a simpler first mode, includes a releasable connector which will engage over the distal ends of both the first extensions and the second extensions which, as noted, will extend to a connection with the releasable connecter at the mount, which is engaged to the body of the vehicle cover at the central area thereof. This releasable connector is preferred, in all modes of the device, and allows the user to stretch each of the two first extensions of the first elastic member and each of the two second extensions of the second elastic member, and thereby easily adjust the relative biasing force of each, independently. Such releasable connectors may be any connector or fastener which allows the user to stretch each one of either or both of the two first or two second extensions, and then to removably engage such in an elongated position.

In such an elongated position, each of the respective first extensions imparts a biasing force on opposite sides of the cover body, between the first elastic member within the first passage at the front of the body and the mounts engaged with both sides at a mid portion of the vehicle cover body. The second extensions, in such an elongated position engaged with the connector, impart a secondary biasing force on opposite sides of the cover body between the second elastic member within the second passage at the rear of the body, and the mounts engaged with both sides of the body of the device, at a mid portion of the vehicle cover body.

The mount, as described herein, may actually be the fastener itself in an engagement with a central area of the body of the vehicle cover which is in between the front and rear thereof. The mount, in a current preferred mode of the device, may be a ring having a passage therethrough which is engaged directly or by a strap or flexible connection to the central area of the body of the vehicle cover. Where a ring is employed, the connector, which engages the respective first and second extensions in the biased elongated positioning, will either be connected to the mount or will have a diameter larger than the opening in the ring so as to prevent passage therethrough.

The connectors in all modes, as noted, will removably engage with both the first extensions from the first elastic member located on both sides of the mounted cover body and both the second extensions of the second elastic member which are in a mirrored fashion located on both sides of the mounted vehicle cover body. Any connector, which will engage and easily release and which during the engagement will hold the respective sections of the elastic member in position, when so engaged, as would occur to those skilled in the art, will work. However, a current preferred connector is a spring loaded cord lock. Such spring loaded cord locks have one or a plurality of apertures communicating therethrough which are sized for communication of the distal ends of the respective elastic extensions therethrough.

In use, with the cord lock or a similar releasably engageable connector, the user will pull each of the pairs of respective first extensions and second extensions through a respective aperture or passage or track on the connector. Once the desired amount of biasing force is achieved on each respective extension, the user will engage or allow the connector to automatically engage therewith. This engagement acts to removably hold the respective elastic extension in a stretched length which imparts a biasing force toward both ends thereof. Thus, where used, the term removably engageable connector is meant to be any connector which will removably engage with elastic member extensions and hold them in a stretched or elongated configuration until released. A wide variety of such removably engageable connectors are known and available to those skilled in the art and are considered incorporated herein.

This independent adjustability of the biasing retraction force of each of the respective elastic extensions is particularly preferred. This is because it allows the user to adjust the biasing force imparted by each of the first and second elastic members independently by adjusting of the respective each of the two respective first extensions and the two second extensions, to impart a desired force to the elastic members at the front and rear against the vehicle. It is this biasing force, from the front toward the middle area of the body and the rear toward the middle area of the body of the vehicle cover, which holds the vehicle cover especially secure upon the vehicle. Further, once the user adjusts the respective biasing force of each respective extension, they need not do it again unless more or less biasing force is desired.

In a mode of the vehicle cover device which operates in the same fashion with the first and second elastic members and extensions therefrom, the vehicle cover device also includes flexible central engagement members extending on opposing sides of the body of the vehicle cover. Each central engagement member extends from the central area of both sides of the body of the vehicle cover which as noted is in-between the front and rear sides thereof. Each of the central engagement members preferably has a clip thereon, which is configured to removably engage with a fixed lower surface on both sides of the vehicle or with a fixed surface on a carrier for the vehicle such as a boat trailer.

Preferred with each such clip is a projection extending therefrom which is configured for contact with the fingers or thumb of the user. In use, this projection allows the user to push each clip downward and thereby more easily overcome the biasing force of either or both of the engagement members and/or the first extension and the second extension, described above. The clip works well to hold the engagement member in biased contact with the vehicle lower surface as well as to maintain the first extension from the first elastic member and the second extension from the second elastic member stretched and imparting a contracting biasing force. With the projection, it is much easier for the user to push it downward to an engagement with the extension.

With respect to the above description, before explaining at least one preferred embodiment of the herein disclosed vehicle cover and securement system therefor in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other vehicle cover structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially” where not specifically otherwise defined, is plus or minus five percent.

Objects, features, and advantages of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features of the vehicle cover system herein. It is intended that the embodiments and figures disclosed herein are to be considered illustrative rather than limiting.

In the drawings:

FIG. 1 depicts a mode of the vehicle covering device herein showing the cover body and showing independently adjustable first and second biasing members, each having respective extensions which are adjustably connected to mounts centrally positioned on both sides of the vehicle cover.

FIG. 2 depicts the vehicle cover device herein, in a similar fashion to that of FIG. 1, which also includes on both sides of the vehicle cover body, a flexible central engagement member having a clip thereon which is configured to removably engage with a lower surface on both sides of the vehicle.

FIG. 3 shows the vehicle cover device where the vehicle cover body is configured for covering a passenger car or truck and includes the two independently adjustable first and second biasing member extensions on both sides thereof, which extend to the front and rear of the vehicle being covered.

FIG. 4 shows the vehicle cover device, as in FIG. 3, with the additional inclusion of the flexible central engagement members on each side of the body, each with a clip thereon, which are configured to removably engage with a lower surface, on both sides of the vehicle.

FIG. 5 depicts the vehicle cover device having a body which is configured for covering a boat or other marine vehicle and showing the independently adjustable biasing members which are located on both sides of the vehicle cover.

FIG. 6 depicts the vehicle cover device, as in FIG. 5, having the two flexible central engagement members with the clips thereon on each side of the body, both of which are configured to removably engage with a lower surface on both sides of the vehicle or a carrier for the vehicle.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the vehicle cover device as it is oriented and appears in the drawings and are used for convenience only. Any such terms are not intended to be limiting or to imply that the vehicle cover device has to be used or positioned in any particular orientation.

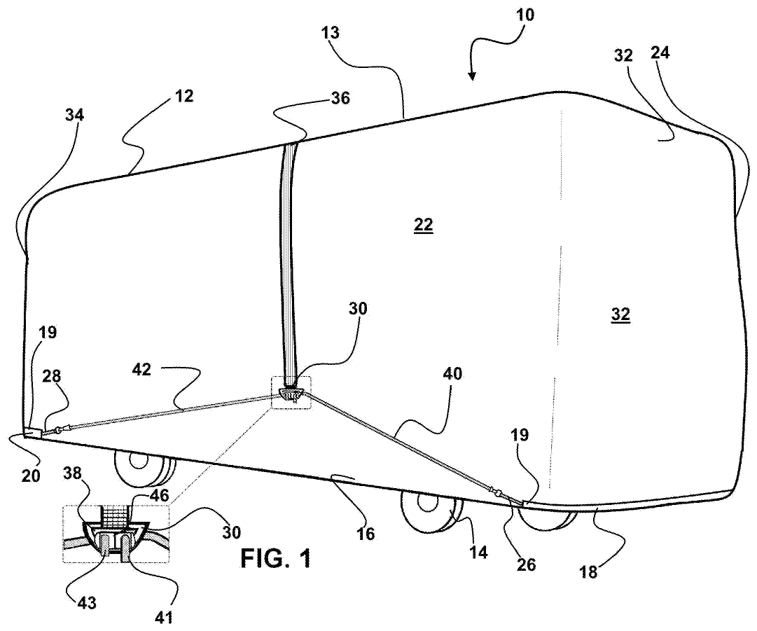

Now referring to drawings in FIGS. 1-6, wherein similar components are identified by like reference numerals, there is seen in FIG. 1 the vehicle cover device 10 herein. As shown, the body 12 is formed of woven, knitted, or other flexible fabric material which is sewn or otherwise formed to the body 12 which has an interior cavity sized to cover the chosen underlying vehicle 14 which, in FIG. 1, is a recreational style vehicle 14. This interior cavity is defined by portions of the body 12 which include a top surface 13 which communicates between intersections thereof with a first side 22 of the body 12, a second side 24 of the body 12, a front end 32 of the body 12 and a rear end 34 of the body 12. Thus, the first side 22 and second side 24 and front end 32 and rear end 34 are all formed of intersecting portions of the body 12 and surround and define the interior cavity thereof which is sized for positioning of the vehicle 14 therein.

The first side 17 or surface extends substantially from the top or top surface 13 to the lower edge 16 of the body 12. In a similar fashion, the front end 32, rear end 34, and second side 19 of the body 12 have fabric surfaces which extend from respective first ends thereof in communication with the top surface 13, to the lower edge 16 of the body 12.

Positioned at or adjacent the lower edge 16 of the body 12, at a front end 32 of the body 12 of the cover is a first passage 18 which is formed by folding the lower edge 16 and sewing the fabric to form the first passage 18 or by sewing or adhering or otherwise engaging a piece of fabric onto the surface of the body 12 in a conventional fashion. In the same manner, at the lower edge 16 of the body 12 on the rear end 34 of the body 12 of the device 10 is formed a second passage 20. By at or adjacent is meant that the respective passages are formed as part of the lower edge 16, or, within a distance of 6 inches from the lower edge 16.

While not required for the device 10 to operate, preferably both the first passage 18 and the second passage 20 are formed in a manner wherein a respective end portion 19 thereof which wrap around the respective front end 32 and rear end 34 of the body 12. In this fashion these end portions 19 on both ends of the first passage 18 and second passage 20 extend onto the first side surface 22 and onto an opposite second side surface 24 of the body 12 of the device 10.

The inclusion of extension or end portions 19 are preferred because such provides a directional exit to both ends of the first elastic member 26 slidably engaged in the first passage 18 and second elastic member 28 slidably engaged in the second passage 20. This directional exit allows the flexible elastic first elastic member 26 and second elastic member 28 to extend from the two opposing ends of their respective passage in a direction and plane of the first side 22 and second side 24 toward a central area of the first side 22 and second side 24 in an aligned fashion.

Further, the wrap around of all of the end portions 19, forms a wrap around of both elastic biased engagements against the underlying vehicle or below an edge thereof, to improve the grip of the body 12 on the vehicle 14. Such a wrap around exit also avoids damage to the material forming the body 12 from chaffing and provides a non slip curved engagement of each of the two ends of the body 12 to hold it on the vehicle 14.

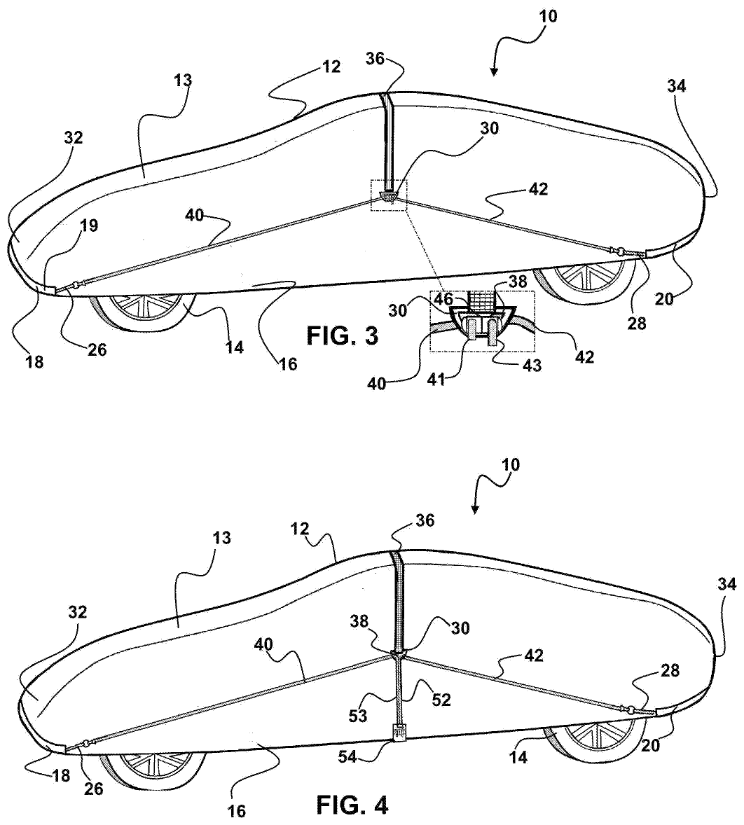

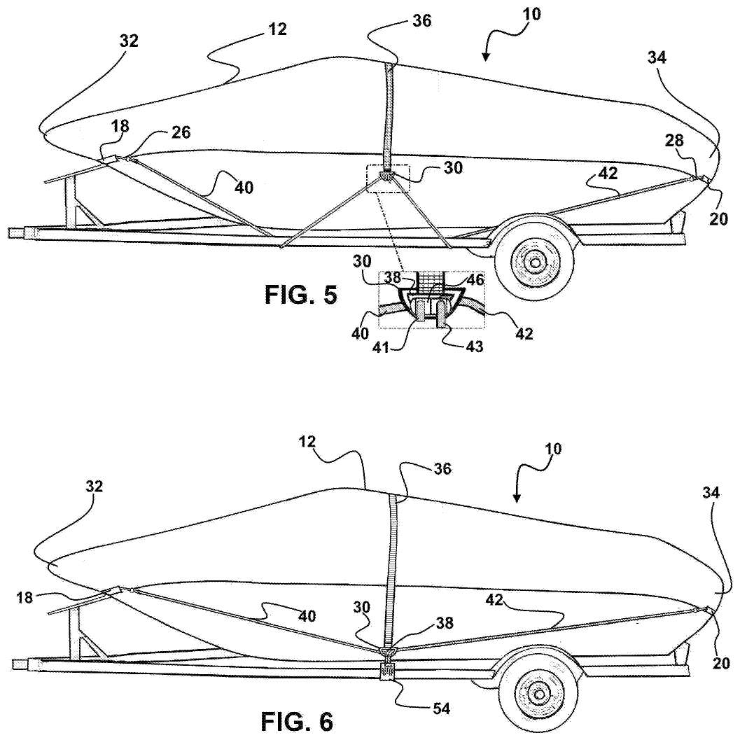

As also shown in FIG. 1 and also in FIG. 3 and FIG. 5, the body 12 of the device 10 includes a mount 30 in an engagement with the body 12 at a central area on each of the first side 22 and second side 24 of the body 12. By central area is meant in between the front end 32 and rear end 34 of the body 12, preferably at an elevation thereon above the lower edge 16 such as substantially between 6 to 60 inches above the lower edge 16, which forms an upward angle to the stretched elastic member extensions 40 and 42 of both the first and second elastic members, from the opposite ends of the first passage 18 and second passage 20.

These member extensions communicating at an upward angle impart a bias to both the stretched elastic members 26 and 28, which is both toward the vehicle 14 and inclining upward rather than just a horizontal or planar biasing force. While not shown, the mount 30 in the central area of the second side 24 of the body 12 would be configured the same as that shown on the first side 22 of the body 12. By upward angle, therefore herein, is meant that the elastic member extensions or end portions 40 and 42, of both the first and second elastic members 26 and 28, exit at open ends of a respective one of the first passage 18 or second passage 20 and incline, from the point of exit, to their distal ends 41 and 43 and to a connection to the mount 30 or connector, if serving as the mount 30.

These mounts 30, positioned on both the first side 22 and second side 24 of the body 12, may be engaged to the body 12 itself or may include engagement adjacent to or with a central reinforcing strap 36, which may extend across the top 13 and both the first side 22 and second side 24 of the body 12. The central reinforcing strap 36 is, preferably, formed of a flexible belt or webbing material, much like seat belt material or the like, and acts to reinforce and better hold the center area of the body 12 in a covering engagement over the vehicle 14, such as shown in the figure.

As noted, the mount 30 is formed with an opening 38 communicating therethrough. The opening 38 is configured for passage of the respective distal ends 41 and 43 of two first member extensions 40 from the first elastic member 26 and from the second elastic member 28.

As shown in the drawings, the first member extensions 40 may be end portions of the first elastic member 26, itself, or may be a separate elastic extension segment engaged to the ends of the first elastic member 26. Thus, by a connection of the distal ends 41 and 43 with a mount 30 is meant a communication thereof through an opening 38 in the mount 30, and then tying them to the mount 30 or attaching a connector 46 to them to hold them in position and set length communicating through the opening in the mount 30. The distal ends can either be at end portions of the first elastic member 26 and second elastic member 28 extending to distal ends 41 and 43, or distal ends of elastic extensions or segments engaged to the ends of the first elastic member 26 and second elastic member 28 at one end thereof, and which then extend to distal ends 41 and 43.

As noted, the two first elastic extensions 40 of the first elastic member 26 are situated on opposite sides of the body 12 and extend from the opposing ends of the first passage 18, preferably, at the upward angle to the mount 30. In a similar fashion, the two second member extensions 42 of the second elastic member 28 are situated on both the first side 22 and second side 24 of the body 12 and extend from the opposing ends of the second passage 20 to the mounts situated on the first side 22 and second side 24, in the same fashion.

As noted, the first member extensions 40 may be portions of the first elastic member 26 which extend from both ends of the first passage 18 which form a connection with the mount 30. Alternatively, they may be separate elastic members which connect at a first end with a fastener 44, such as with hooks or tying or otherwise, to both of the respective two ends of the first elastic member 26 and thereby, form the connections for the ends of the first elastic member 26 with the mount 30. The same configuration can be employed with the second member extensions 42, to form the connection to the mount for the ends of the second elastic member, or where there are elongated end portions of the second elastic member at both ends forming connections with the mount 30.

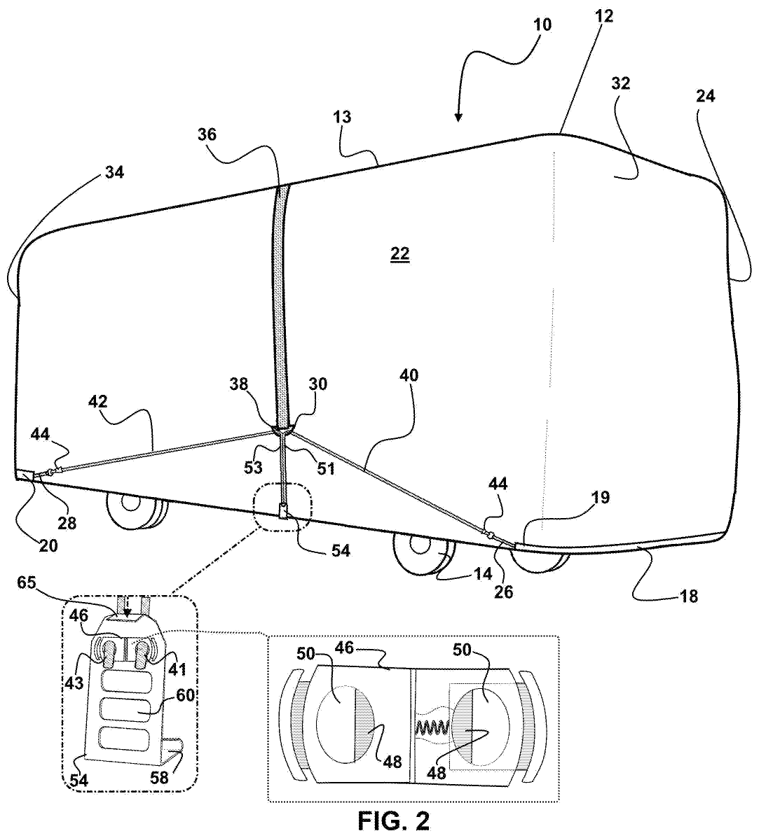

In either configuration, the first member extensions 40 extend to the distal ends 41 and are positionable to a connection with the mount 30, such as by passing through the opening 38 and being removable engaged with a connector 46 (FIG. 2). The second member extensions 42 also extend to the distal ends 43 which are positionable to a connection with the mount 30, such as by passing them through the opening 38 and engaging them with a connector 46, as shown in enlarged format in FIG. 2. The connector 46 can be any connector to which the user can stretch and then removably engage the ends of the first member extensions 40 and second member extensions 42 therewith and thereby hold a connection to a respective connector 30.

A current preferred such connector 46 is a cord lock type connector which has biased retainers 48 positioned to translate within apertures 50. In this mode of the connector 46, the distal ends 41 and 43 are communicated through the opening 38 in the mount 30 and then through the respective aperture 50, a length, to elongate and impart a desired biasing force to both the first member extensions 40 and second member extensions 42, which in turn stretch both the first elastic member and second elastic member.

Once the biasing force on each extension is adjusted to a force which pulls on and extends the first elastic member 26 and second elastic member 28 to cause the lower edge 16 of the body 12, in areas where the first passage 18 and second passage 20 are positioned, to curl around and under the body of the vehicle 14 in biased contacts. The retainers 48 form contacts with the first and second member extensions to hold the connection with the mount 30 and thereby maintain the biasing force. The connector 46 may be engaged to the central area of the body 12 itself and operate as the mount 30 itself, thereby eliminating the need for the separate mount 30. Thus, the term mount herein can be the connector, if fixed in engagement to the cover.

In another mode, allowing the ongoing biasing forces to be held primarily by the mount 30, the connector 46 would be engaged with, or positioned on, a first side of the mount 30, in a manner allowing for independent engagement of both the first member extension 40 and second member extension 42 thereto. In this mode, the distal ends 41 of the first member extensions 40 and the distal ends 43 of the second member extensions 42 can communicate through the opening 38 in the mount 30. They can then be independently engaged with a connector 46, which has a diameter sized larger than the largest cross section of the opening 38. So configured, it will not pass through the opening 38 and will hold the two member extensions stretched and imparting the above noted biasing force.

In this fashion, the user need only fit the body 12 of the respective cover device 10 over the vehicle 14, and then adjust the biasing force of the first member extensions 40 and the second member extensions 42 to a desired amount. This causes the first elastic member 26, within the first passage 18, to stretch and impart a biasing force to the front 32 of the body 12, at the lower edge 16, toward and against and the vehicle 14 at an inclining angle, to form a biased contact at the front 32. The same upward biased contact of the second elastic member 28 in the second passage 20 is imparted to the rear 34 of the body 12. Subsequent engagements of the body 12 over the vehicle 14 are made easier since the upward angled biasing force is imparted once the cover is engaged and slid down onto the vehicle 14.

Shown in FIG. 2 and in FIG. 4 and FIG. 6 is another mode of the device 10 which also includes a mounting clip 54. This mode of the device 10 provides an extra engagement of the central portion of the body 12 of the cover to the underlying vehicle 14 or a carrier (FIGS. 5-6) for the vehicle 14 such as a trailer.

In this mode, a distal portion 52 of the first member extension 40 and a distal portion 53 of the second member extensions 42 extend between the engagement through the opening 38 in the mount 30 and then to a clip 54. The first member extension 40 and second member extension 42 are routed through the opening 38 in the mount 30 and are redirected downward. In this mode, the distal ends 41 of the first member extensions 40 and the distal ends 43 of the second member extensions 42 can communicate through the opening 38 in the mount 30 and be held by a clip 54.

In this fashion, pushing the clip 54 downward to an engagement of a second end 58 of the clip to the vehicle 14 or carrier, will cause elongation and impart biasing force to each of the first distal portion 52 and second distal portion 53 and respectively onward to both the first member extension 40 and second member extension 42.

Two different biasing forces are imparted to the body 12 in this mode for extra securement. A first biasing force of the first distal portion 52 and second distal portion, between the clip 54 and the mount 30, will pull the mount 30 and central area of the body 12 downward toward the bottom of the vehicle 12. Concurrently, the second biasing force or an angled biasing force is imparted by the stretching of the first member extensions 40 which pull on both ends of the first elastic member 26 and bias the front of the body 12 toward the front of the vehicle 14, and the elongation of the second distal portions 53 which stretches the second elastic members 28 to generate the angled biasing force on both ends of the second elastic member 28, which pulls the rear of the body 12 to and against the rear of the vehicle 14.

A connection of the distal ends 41 and 43 through or with the clip 54 can be simply fixed such as by tying or otherwise forming fixed connections thereto. More preferred is a connection of the two ends 41 and 43 of the first and second distal portions 53 and 51 with the clip 54, using a positioning of a connector 46 on, or adjacent to, a clip opening 60 in the clip 54. In this fashion the distal ends 41 and 43 of the first and second extension members 40 and 42, are communicated through the clip opening 60, and engaged with the connector 46 by the retainers 48. The inclusion of the connector 46, to form the connections to the clip 54, allows a greater degree of adjustment of the elongation of the first member extension 40 and second member extension 42 to adjust the bias, noted above, which they respectively impart.

With regard to the clip 54, as noted above, a projection 65 extending away from one side of the clip 54 is preferred in modes of the device 10 herein wherein a clip 54 is employed. It was found, in experimentation, that the projection 65 extending from a central area thereof, which is configured for contact and pushing upon by the fingers of the user during use, made it easier for the user to stretch the first and second distal portions 53 and 51, with the clip 54 during the attachment of the clip to the vehicle 14 or carrier therefor.

This vehicle covering system herein has other applications potentially, and one skilled in the art could discover these. The description of the features of the vehicle cover invention herein, does not limit the claims of this application and applications developed by those skilled in the art will be included in this invention.

While all of the fundamental characteristics and features of the vehicle cover invention have been shown and described herein, with reference to particular embodiments thereof, a latitude of modification, various changes and substitutions are intended in the foregoing disclosure and it will be apparent that in some instances, some features of the vehicle cover invention may be employed without a corresponding use of other features without departing from the scope of the invention as set forth. It should also be understood that various substitutions, modifications, and variations may be made by those skilled in the art without departing from the spirit or scope of the vehicle cover invention herein. Consequently, all such modifications and variations and substitutions are included within the scope of the invention as defined by the following claims.

What is claimed:

1. A vehicle cover, comprising:
a flexible body having a top, a first side, a second side, a front end, and a rear end;
said body having an interior cavity defined by an area between said top, said first side, said second side, said front end and said rear end, said interior cavity positionable over an vehicle;
said body having a lower edge extending around said first side, said second side, said front side and said rear side;
a first passage formed at or adjacent said lower edge of said body along said front end;
said first passage having a first elastic member extending therethrough;
a second passage formed at or adjacent said lower edge of said body along said rear end;
said second passage having a second elastic member extending therethrough;
a first mount positioned on said side first of said body;
a second mount positioned on said second side of said body;
a first distal end of said first elastic member and a first distal end of said second elastic member both positionable to a first connection with a said first mount;
a second distal end of said first elastic member and a second distal end of said second elastic member both positionable to a second connection with a said second mount;
wherein, with said first distal end of said first elastic member and said first distal end of said second elastic member in said first connection, and said second distal end of said first elastic member and said second distal end of said second elastic member in said second connection, said first elastic member is stretched to impart a first biasing force along a length of said first passage in a direction toward said vehicle positioned within said interior cavity, and said second elastic member is stretched to impart a second biasing force along a length of said second passage in a direction toward said vehicle positioned within said interior cavity.

2. The vehicle cover of claim 1, additionally comprising:
said first mount being positioned in a central area of said first side;
said second mount being positioned in a central area of said second side;
said first elastic member having a first member extension portion thereof extending from a first end of said first passage to said first distal end thereof;
said second elastic member having a first member extension portion thereof extending from a first end of said second passage to said first distal end thereof;
said first elastic member having a second member extension portion thereof extending from a second end of said first passage to said second distal end thereof;
said second elastic member having a second member extension portion thereof extending from a second end of said second passage to said second distal end thereof;
said first member extension portion of said first elastic member extending at an upward angle thereof, from said first end of said first passage to said first connection with said first mount;
said first member extension portion of said second elastic member extending at an upward angle thereof, from said first end of said second passage to said first connection with said first mount;
said second member extension portion of said first elastic member extending at an upward angle thereof, from said second end of said first passage to said second connection with said second mount; and
said second member extension portion of said second elastic member extending at an upward angle thereof, from a second end of said second passage to said second connection with said second mount.

3. The vehicle cover of claim 2, additionally comprising:
said first mount having a first opening therethrough;
said second mount having a second opening therethrough;
said first connection of said first member extension of said first elastic member with said first mount being a passage thereof through said first opening;
said first connection of said first member extension of said second elastic member with said first mount being a passage thereof through said first opening;
said second connection of said second member portion of said first elastic member with said second mount being a passage thereof through said second opening;
said second connection of said second member extension of said second elastic member with said second mount being a passage thereof through said second opening;
said first member extension of said first elastic member and said first member extension of said second elastic member both being connected to first clip;
second member portion of said first elastic member and said second member extension of said second elastic member both being engaged to a second clip;
said first clip engageable to a first engagement point on a first side of said vehicle by a stretching of said first member extension of said first elastic member and said first member extension of said second elastic member in a direction away from said first mount and toward said first engagement point; and
said second clip engageable to a second engagement point on a second side of said vehicle by a stretching of said second member portion of said first elastic member and said second member extension of said second elastic member in a direction away from said second mount and toward said second engagement point.

4. The vehicle cover of claim 3, additionally comprising:
said first clip having a first clip projection thereon, said first clip projection being configured for contact therewith and pushing upon by the fingers of a user during said stretching of said first member extension of said first elastic member and said first member extension of said second elastic member in said direction away from said first mount and toward said first engagement point; and
said second clip having a second clip projection thereon, said second clip projection being configured for contact therewith and pushing upon by the fingers of a user during said stretching of said stretching of said second member portion of said first elastic member and said second member extension of said second elastic member in said direction away from said second mount and toward said second engagement point.
